(19) United States
(12) Patent Application Publication
(10) Pub. No.: US 2025/0131493 A1
(43) Pub. Date: Apr. 24, 2025

(54) INTEGRATED FINANCIAL SERVICES PLATFORMS AND METHODS OF USE

(71) Applicant: Figure Technologies, Inc., San Francisco, CA (US)

(72) Inventors: Li Duan, Wayne, PA (US); Rana Rae DeWall, Bozeman, MT (US); Larry Matthew Conroy, Helena, MT (US)

(21) Appl. No.: 18/800,872

(22) Filed: Aug. 12, 2024

Related U.S. Application Data
(63) Continuation of application No. PCT/US2023/012950, filed on Feb. 13, 2023.
(60) Provisional application No. 63/310,053, filed on Feb. 14, 2022.

(51) Int. Cl. G06Q 40/02; G06K 19/06; G06Q 20/10; G06Q 20/32; G06Q 20/36; H04L 9/00

(52) U.S. Cl. CPC G06Q 40/02; G06K 19/06037; G06Q 20/108; G06Q 20/3276; G06Q 20/36; H04L 9/50; H04L 2209/56

(57) ABSTRACT

The present disclosure provides a financial services platform and method of transferring funds using a financial services platform. The platform may comprise a plurality of rails. The plurality of rails may be based or built on a blockchain. The plurality of rails may be configured to enable a plurality of financial transactions comprising direct deposits, money transfers, debits, financed purchases, and point of sale loans between a plurality of parties. The platform may further comprise an application for implementing the plurality of rails. The application may be executable on a plurality of devices and comprises a graphical interface for facilitating the financial transactions between the plurality of parties. At least one of the financial transactions may be completed by using a visual code that is indicative or representative of a transaction amount or settlement between a first part and a second party.

### CROSS-REFERENCE

This application is a continuation application of International Application No. PCT/US2023/012950, filed Feb. 13, 2023, which claims the benefit of U.S. Provisional Application Ser. No. 63/310,053, filed Feb. 14, 2022, which is entirely incorporated herein by reference.

### BACKGROUND

Conventional banking systems facilitate transactions through transfer of fiat currency. These banking systems use transaction and payment rails built on fiat currency. Traditional banking systems use internal ledgers to account for the balance of each user account. Such internal ledgers can be subject to external threats and must implement safeguards that increase the cost and time of transactions between accounts that use these ledger systems. The transfer of fiat currency from one account to another can be subject to fraud, delay, and transaction cost.

### SUMMARY

The present disclosure is directed to systems and methods for financial transactions based on blockchain. Financial transactions backed by a blockchain are more secure than transactions of traditional, fiat currency. Blockchain transactions are more efficient in costs associated with the transactions. Financial transactions based on blockchain can offer more flexibility and customization than traditional banking systems.

An integrated financial services platform, comprising a plurality of rails that are based or built on a blockchain, wherein the plurality of rails are configured to enable a plurality of financial transactions comprising direct deposits, money transfers, debits, financed purchases, or point of sale loans between a plurality of parties; and an application for implementing the plurality of rails, wherein the application is executable on a plurality of devices and comprises a graphical user interface for facilitating the financial transactions between the plurality of parties, wherein at least one of the financial transactions is completed by using a visual code that is indicative or representative of a transaction amount or settlement between a first party and a second party.

In some embodiments, the application is a mobile application (app) or web-based.

In some embodiments, the application is configurable or customizable by, or for one or more business or financial entities.

In some embodiments, the first party is a merchant or service provider, and the second party is a consumer.

In some embodiments, the first party and the second party are individual end users of the platform.

In some embodiments, the visual code comprises a two-dimensional code.

In some embodiments, the two-dimensional code comprises a quick response (QR) code.

In some embodiments, the visual code is associated with an invoice from the merchant or service provider to the consumer.

In some embodiments, the application is configured to generate the visual code for the first party, wherein the visual code is subsequently displayed or transmitted by the first party to the second party.

In some embodiments, the application is configured to enable the first party to transmit the visual code via text message or email to the second party.

In some embodiments, the at least one financial transaction is completed or settled substantially in real-time upon the second party scanning or processing the visual code using a device.

In some embodiments, the transaction amount is reflected substantially in real-time in the first party's account upon completion or settlement of the at least one financial transaction.

In some embodiments, the transaction amount is reflected in the first party's account in less than 48 hours.

In some embodiments, the transaction amount is reflected in the first party's account in less than 1 minute.

In some embodiments, the visual code comprises metadata about the first party, nature of the at least one financial transaction, and a timestamp.

In some embodiments, the visual code further comprises metadata about the second party.

In some embodiments, the visual code is specific only to the second party, such that the at least one financial transaction is unable to be completed if the visual code is scanned or processed by another party that is not the second party.

In some embodiments, the visual code is displayable on a mobile device, a desktop computing device, or a point-of-sale terminal.

In some embodiments, the application is configured to send the visual code asynchronously if the at least one financial transaction is an offline transaction.

In some embodiments, the platform is configured to integrate transactional data from the plurality of financial transactions into a contextual rewards program offered by one or more of the plurality of parties.

In some embodiments, the platform is configured to use the blockchain as a system or a record for accumulation, redemption or transfer of points or rewards for the contextual rewards program.

In some embodiments, the platform is configured to generate one or more geolocation alerts associated with the contextual rewards program, based on a geographical proximity between a first party that is offering the contextual rewards program and a second party that is a customer or potential customer of the first party.

In some embodiments, the platform further comprises an analytics module that is configured to apply one or more machine learning algorithms to transactional data from the plurality of financial transactions for an underwriting process.

In some embodiments, the application is configured to generate one or more visual codes that are indicative of credit offers for extending to one or more parties based on results of the underwriting process.

In some embodiments, the application is configured to display or transmit the visual codes that are indicative of the credit offers to the one or more parties.

In some embodiments, an acceptance of the credit offers occurs substantially in real-time upon the one or more parties scanning or processing the one or more visual codes.

In some embodiments, after the one or more parties have accepted the credit offers, the platform is configured to enable online loan servicing through loan providers extracting loan repayments from revenue that the one or more parties receive from subsequent sale transactions.

In some embodiments, the platform is configured to host a plurality of accounts with funds or balances, and wherein the blockchain is configured to maintain all of the plurality of accounts, the funds or balances, and the plurality of financial transactions, by extending across the plurality of rails and supporting a fiat bridge interface to at least some of the rails.

In some embodiments, the platform is configured to allow the plurality of parties to earn transaction income from the plurality of financial transactions occurring across the plurality of rails.

In some embodiments, the platform is configured to incorporate and custody cryptocurrency wallets.

In some embodiments, the plurality of parties are accountholders on the platform, and wherein each account associated with the corresponding accountholders represents a wallet on the blockchain.

In some embodiments, the first party and the second party are individual end users of the platform.

In an aspect, the present disclosure provides a method of transferring funds using an integrated financial services platform, comprising (a) initiating, by an accountholder, a fund transfer request that is transmitted to an account application programming interface (API); (b) generating, by the account API, (1) a pull transaction when the fund transfer request is an inbound transaction, or (2) a redemption reference memo when the fund transfer request is an outbound transaction; (c) processing, by an omnibus bank, (1) the pull transaction to pull funds or (2) the redemption reference memo to push funds; (d) broadcasting, by the omnibus bank to a blockchain, (1) a mint and transfer transaction when funds are pulled from the omnibus bank, or (2) a burn transaction when funds are pushed to the omnibus bank; (e) returning, from the blockchain to the omnibus bank, (1) a first signal that indicates awaiting a first transaction block cut for minting stablecoin based on the mint and transfer transaction, or (2) a second signal that indicates awaiting a second transaction block cut for burning stablecoin based on the burn transaction; and (f) transmitting, by the omnibus bank to the account API, (1) a first confirmation signal that marks the pull transaction as complete upon completion of the first transaction block cut for minting stablecoin, or (2) a second confirmation signal that marks the push transaction as complete upon completion of the second transaction block cut for burning stablecoin.

In some embodiments, the fund transfer request comprises an automated clearing house (ACH) transfer.

In some embodiments, (b) further comprises broadcasting, by the account API, a transfer transaction with the redemption reference memo to the blockchain.

In some embodiments, the method further comprises returning, from the blockchain to the omnibus bank, an intermediate signal that indicates awaiting the intermediate transaction block cut.

In some embodiments, the funds are pushed to the omnibus bank upon completion of the intermediate transaction block cut.

In some embodiments, in (d), the burn transaction is broadcasted from the omnibus bank to the blockchain after the funds are pushed to the omnibus bank.

In some embodiments, the pull transaction is a credit or transfer of funds into the accountholder's account, and corresponds to the minting of stablecoin.

In some embodiments, the push transaction is a debit or transfer out of funds from the accountholder's account, and corresponds to the burning of stablecoin.

In some embodiments, the method further comprises using the integrated financial services platform to enable in-network transactions for transferring stablecoin between a plurality of accountholders, by initiating, by a first accountholder, a coin transfer request to a second accountholder, wherein the coin transfer request is transmitted to the account API; broadcasting, by the account API to the blockchain, a transfer transaction associated with the coin transfer request; returning, from the blockchain to the account API, a signal that indicates awaiting a transaction block cut for transferring stablecoin between the first accountholder and the second accountholder; and generating, by the account API, a confirmation signal that marks the transaction as complete upon completion of the transaction block cut.

In some embodiments, the method further comprises using the integrated financial services platform to enable accountholders to apply for a debit card whereby debit transactions are ledgered against stablecoin wallets held by the accountholders.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, and the accompanying drawings (also “Figure” and “FIG.” herein), of which:

FIG. 1 schematically illustrates an integrated financial services platform in accordance with some embodiments.

FIGS. 2A and 2B schematically illustrate an example of a visual code that is indicative or representative of a transaction amount or settlement between a first party and a second party in accordance with some embodiments.

FIG. 3 schematically illustrates a data flow structure of an integrated financial services platform in accordance with some embodiments.

FIG. 4 schematically illustrates a process flow of an integrated financial services platform configured to create a user account in accordance with some embodiments.

FIG. 5 schematically illustrates a process flow of an integrated financial services platform configured to initiate an automated clearing house (ACH) pull transaction, where an amount of fiat currency is exchanged for one or more tokens of a blockchain in accordance with some embodiments.

FIG. 6 schematically illustrates a process flow of an integrated financial services platform configured to initiate an ACH push transaction, where one or more tokens of a blockchain are exchanged for an amount of fiat currency in accordance with some embodiments.

FIG. 7 schematically illustrates a process flow of an integrated financial services platform configured to facilitate an in-network transaction in accordance with some embodiments.

FIG. 8 schematically illustrates a process flow of an integrated financial services platform configured to facilitate the application for and creation of a debit card in accordance with some embodiments.

FIG. 9 schematically illustrates an exemplary computer system that is programmed or otherwise configured to implement one or more methods provided herein.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the scope of the present disclosure. It should be understood that various alternatives to the embodiments described herein may be employed.

In an aspect, the present disclosure provides an integrated financial services platform. The platform may comprise one or more payment rails. The plurality of rails may be configured to enable a plurality of financial transactions. Non-limiting examples of the financial transactions may include direct deposits, money transfers, debits, financed purchases, and point of sale loans between a plurality (e.g., two or more) parties.

The platform may comprise one or more applications for implementing the plurality of rails. A rail is a platform or network that transfers currency or other assets between two or more parties. The plurality of rails may comprise a plurality of different currencies, assets, or types of financial transactions. For example, the plurality of rails may comprise a rail for each financial transaction of the group of financial transactions comprising money transfer, loan structuring, invoice settlement between businesses or between a business and a customer, and credit issuance. The platform may horizontally and/or vertically integrate the plurality of rails. The platform may be a mobile platform that enables ease of use of the integrated rails for mobile users. Integrating the plurality of rails on the platform may provide increased efficiencies. Integration may increase the efficiency of the time, cost, regulatory review or other metric of a transaction. Integrating the plurality of rails on a mobile platform may provide faster transaction speeds, greater reliability, fewer intermediate steps or channels, and other benefits to end users. In addition, integration of a plurality of rails on a single integrated platform may allow a user to process a large variety of transactions using a single platform.

The one or more applications may be executable on a plurality of devices. In some embodiments, an application may be a mobile application (“app”). The plurality of devices may include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The application may comprise a graphical user interface (GUI) for facilitating one or more financial transactions. The GUI may be rendered on one or more of the devices. The application may facilitate one or more financial transactions between a plurality of parties.

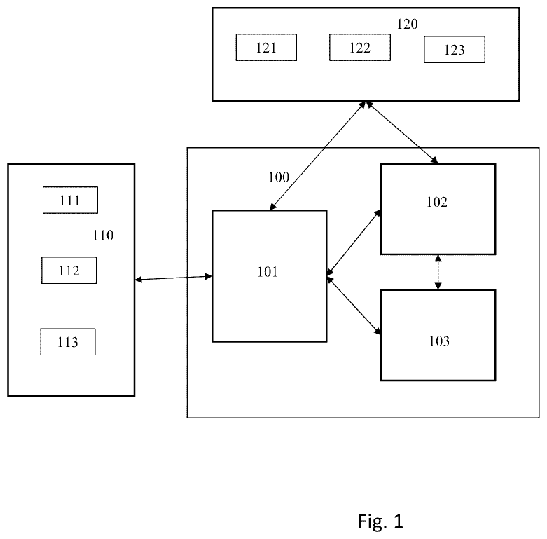

FIG. 1 shows an embodiment of the platform 100. The platform may be operatively linked to a plurality of user devices 110. An application of the platform may be executable on one or more devices 111, 112, 113 of the plurality of devices, 110. The platform 100 may also be in operative communication with a one or more financial institutions 120. The platform may be in operative communication with one or more financial institution accounts 121, 122, 123 of the one or more financial institutions 120.

The platform may comprise an application programming interface (API) 101 configured to implement the plurality of rails of the platform. The API may be in operative communication with an Omnibus Account 102. An Omnibus Account may generally refer to an account held at a financial institution, where one or more owners, of a plurality of owners, hold separate ownership interests in separate assets held within the Omnibus Account. The Omnibus Account and the API may be in operative communication with a distributed ledger (e.g., a blockchain) 103. The distributed ledger may record transactions between two parties of the platform or a party of the platform and one or more parties external to the platform. For example, the blockchain may record a transaction, facilitated by the platform, between a financial institution account 121 and the omnibus account 102, as directed by a user through a user device 111.

### Financial Transaction Rail Based on Blockchain

In an embodiment, the platform described herein may be configured to provide a financial transaction rail. The financial transaction rail may be based on a distributed ledger, such as blockchain. In some cases, the financial transaction rail may be based on a private blockchain network. In some cases, the rail may be based on a publicly accessible blockchain network.

In some cases, the financial transaction rail of the present disclosure may be a merchant payment rail (e.g., a payment rails configured to enable commercial transactions between one or more merchants and one or more consumers). In some embodiments, the payment rail may settle funds exchanged via the payment rail in real time. In some cases, the payment rail based on blockchain may allow users (e.g., merchants) to access settled funds in real time. The term “real-time,” as used herein, generally refers to a response time that does not appear to be of substantial delay to a user. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors. In some embodiments, a response time may be associated with processing of data (such as by a computer processor), transmittal of data (such as by the platform), or other action of the platform.

In some embodiments, the financial transaction rail based on blockchain may reduce transaction fees for merchants using the rail by at least 10%, 20%, 30%, 40%, 50%, 60%, 70%, 80%, 85%, 90%, 95% or more. In some cases, the financial transaction rail based on blockchain may reduce or eliminate chargeback risk. Chargeback risk may generally refer to the risk that a commercial transaction will not settle because of consumer fraud or other invalidation between a merchant and a traditional rail provider (e.g., Visa® credit card).

### Point of Sale Financing

The platform may incorporate the advantages of a credit and debit system. For example, the platform may be configured to link an account of a financial institution insured by the Federal Deposit Insurance Corporation (FDIC), to provide user access to a Visa debit card, enable direct deposit to a user account, and allow users to access automated teller machines (ATMs) of the linked financial institution. The platform may be configured to provide benefits of credit transactions by providing a native API that finances individual transactions on the platform. The financing API may be configured to allow a user (e.g., consumer) to finance a purchase at a point of sale (POS). The financing API may use a traditional Visa debit rail or a financial transaction rail based on blockchain.

In some embodiments, the platform can enable a user (e.g., customer) to pay for a traditional debit card transaction with a financed installment loan purchase. For instance, a consumer may settle with a merchant by accessing a financing from an underwriter of the platform, where the financing comprises an installment loan agreement. In some cases, the platform may enable an underwriting decision (e.g., whether a consumer is qualified to finance a purchase) within a time period, for example in less than two minutes. In some embodiments, the platform may enable a consumer to access credit in real time, such as at the point of sale.

In an aspect, the platform of the present disclosure may allow for API integration. API integration may allow for a custom look and feel of the platform. In some cases, API integration may allow the platform to be integrated with other components or features of a second platform.

### 1. Visual Codes

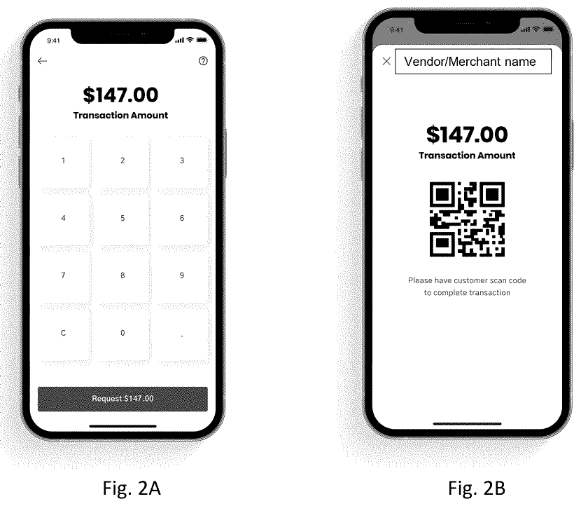

In an aspect, the platform of the present disclosure may provide a visual code to facilitate a financial transaction on the platform. The platform may comprise an application that is executable on a plurality of devices. The application may comprise a graphical user interface. The graphical user interface may be configured to facilitate one or more financial transactions between a plurality of parties. At least one of the financial transactions may be completed using the visual code. FIG. 2A shows an example of in interface of the platform prompting a user to enter information about a transaction. FIG. 2B shows an example of the platform providing a visual code (e.g., a QR code). A visual code may comprise a quick response (QR) code. The visual code may be indicative or representative of a transaction amount or settlement between a first party and a second party. The visual code may comprise information that can be used by the platform to identify a transaction between a first party and a second party. The information may comprise the identities of the parties, an amount of the transaction, a date of the transaction, a description of the goods or services provided, a location of the sale of the goods or services, details regarding a financing of the purchase amount of the goods or services, and/or other information relating to an invoice of the transaction.

As an example, the visual code may represent an invoice of a commercial transaction, such as a dinner bill. The bill, or invoice can include a visual code on the printed or digitally displayed bill to be scanned by the customer(s). Upon scanning the visual code, the application on the customer's device may authenticate the bill and prompt the consumer to pay the bill, such as by initiating a transfer of assets through a rail of the platform to settle the amount owed.

In an example, the visual code may represent a receipt of a commercial transaction, such as payment of monthly rent obligation. Upon payment of a month rent amount via a payment rail of the platform, the platform may generate a visual code representing the details of the paid rent. The visual code may be transmitted to the tenant and the landlord as a receipt of the paid rent. The visual code may be scanned by a device of the tenant or the landlord to recall the details of the rent payment. In another embodiment, the visual code may be generated by one party to reflect a transaction that was not completed using the platform. As an example a tenant pays a landlord in cash, and the landlord enters the transaction details into the platform, the platform generates a visual code representing the transaction, and transmits the visual code as a receipt of the rent transaction to the landlord and the tenant.

The graphical user interface of the application, or the application, may be configured to collect information from the visual code. The graphical user interface, or the application, may collect information from the visual code by scanning, taking a picture, or otherwise analyzing the visual code. The application may use the information collected from the visual code to generate a digital invoice between two parties. The application may present the invoice at the time of scanning of the visual code, to the party responsible for settling the invoice. The application may initiate a transfer of assets from a first user to a second user to settle the amount of the transaction represented by the visual code. The application may prompt either the first user or the second user to either approve or decline payment of the transaction amount via a payment rail of the platform.

In some cases, the visual code of the present disclosure may comprise a representation of data that is configured to be visually analyzed by a system. The visual code may comprise a quick response (QR) code, a universal product code (UPC), or other visual code. The visual code may be in a variety of formats. The visual code may have one or more orientations. The visual code may be a square, rectangle, or another, standard polygonal shape to be identified by a sensor. The visual code may comprise letters and/or images within a frame of the visual code. The visual code may be colored, monochrome, greyscale, or black and white. The visual code may be configured to be imaged by a camera of a device that can run one or more applications of the present disclosure (e.g., a smart phone, tablet, computer with camera, or other system comprising a camera and a processor).

In some cases, the visual code may be transmitted between devices. As a non-limiting example, the visual code may be generated by a device running the application of the platform, and transmitted to a second device running the application of the platform. The visual code may be transmitted as an email, text message, data message through the application, or other digital route. The visual code may also be transmitted by displaying the visual code on a first device and scanning the visual code by a second device. As a non-limiting example, a merchant may enter information into an application of the platform on a first device. The application on the first device may generate the visual code. The graphical user interface of the application of the first device may display the visual code. An application of the platform on a second device may analyze the visual code of the first device (e.g., by imaging the visual code with a camera integrated into the second device). The application of the platform on the second device may initiate (or prompt the user of the second device to initiate) a transfer of assets on the platform to settle the balance of the transaction represented by the visual code. Upon settlement, an application of the platform may transmit a signal to one or more parties of the transaction to confirm the completion of the transaction.

In some cases, the visual code may be used to authenticate a transaction request or receipt (e.g., an invoice). For example, when an invoice and a visual code are transmitted to a user's device, the application on the user's device can detect the presence of the visual code and determine the authenticity of the invoice. The determination of the authenticity of the invoice may be used by the application to prompt or allow the user to complete payment of the invoice.

### 2. Omnibus Account

The platform of the present disclosure can be configured to work with omnibus accounts. An omnibus account may be secured by an FDIC insured financial institution. The omnibus account may be held in the name of an entity providing the financial services platform. The omnibus account may hold the assets of a plurality of users of the platform. The platform may use a distributed ledger (e.g., blockchain) to account for the ownership of the assets in the omnibus account amongst the plurality of users of the platform. The assets within the Omnibus account may comprise one or more of traditional or fiat currency, one or more tokens of a digital currency, or another digital or conventional asset.

### 3. Data Request Flow

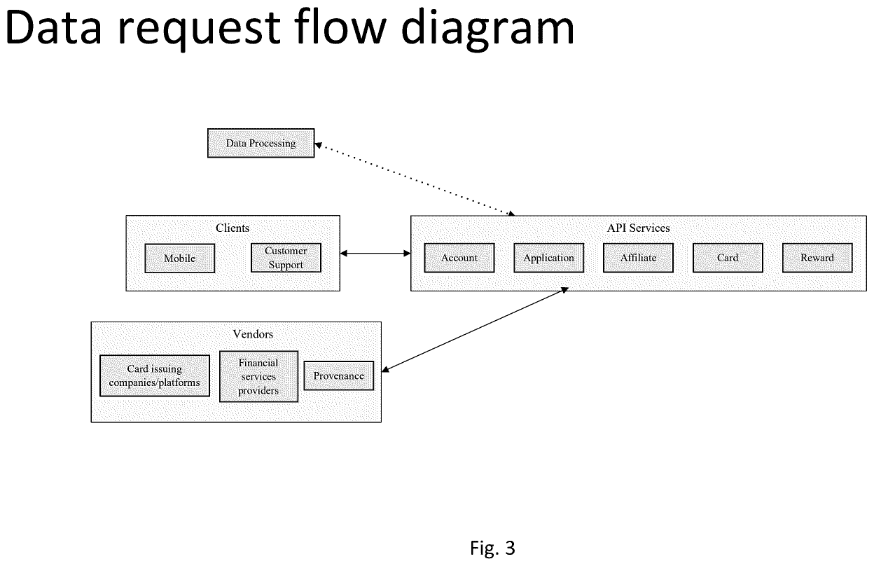

FIG. 3 shows an example of a data structure between clients, API services, and vendors of the platform. In some cases, the platform comprises a data processing layer to facilitate transfer of data between two or more API services of the platform. In some cases, one or more of the API services may communicate directly with one or more third party vendors.

### 4. Account Creation

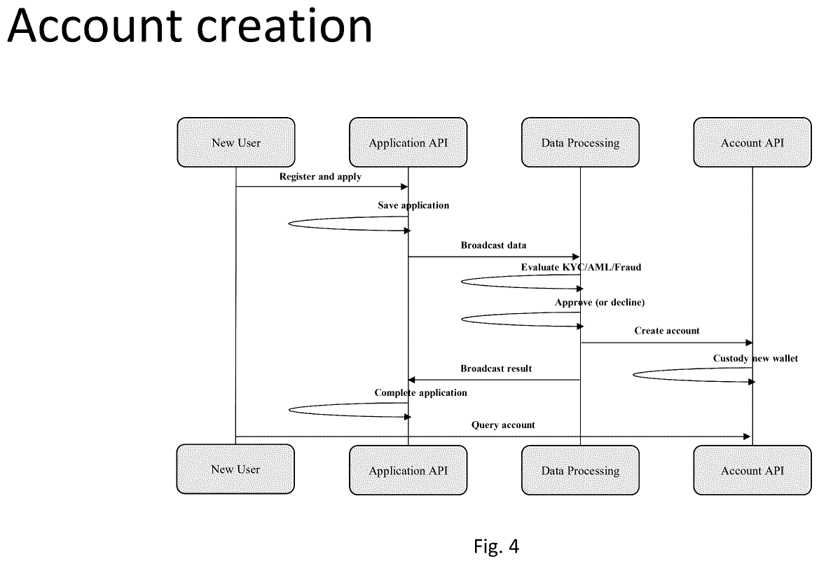

In some cases, the platform described herein can facilitate creation of an account. FIG. 4 shows an example of a process of the platform. The account may be linked to a specific user. The user may be a mobile client. A mobile client may refer, generally, to a user accessing the platform via a mobile device running an application of the platform. The mobile client may interact (e.g., communicate) with an application interface (e.g., API) of an application. Creation of the account may comprise applying for the account and/or registering the account to the user. The user may be prompted to enter user data. The user data may include information relating to the user's qualifications and/or ability to open the account. The user data may comprise information about other accounts at other financial service providers linked to the user.

The user data may comprise personal identification information (PII). The user data may be processed by the financial services platform to verify the user data, verify the identity of the user, or otherwise comply with “know your customer” (KYC) or Anti Money Laundering (AML) guidelines.

The platform may comprise one or more application programming interfaces (APIs). One of these one or more APIs may be an API configured to facilitate a user's application for a new account (e.g., an Application API). The Application API may save the application (e.g., the collection of submitted user data) to the platform. The Application API may broadcast the data to a data processing layer of the platform. The data processing layer may evaluate user data internally and/or with an external (e.g., third party) validator. The internal and/or external validator may approve or decline a user's application for a new account.

The data processing layer may transmit a result of the validation by the data processing layer to an API configured to facilitate account interactions (e.g., an Account API). The Account API may custody a new wallet on behalf of the new user. A wallet, as used herein, may refer generally to a software-based system configured to securely store a user's payment information and accessible to submit payment account information to complete a digital financial transaction. The wallet may refer to an account holding one or more digital assets for the benefit of the wallet user. The wallet may be custodied on a blockchain rail.

The data processing layer may transmit (e.g., broadcast) the result of the validation back to the Application API. The Application API may complete the application for the new account of the new user. After the Application API has completed the application, the new user can query information related to the account through the Account API.

### 5. Financial institution Transfers

In another aspect, the platform of the present disclosure can facilitate transfers of currency or other assets between the platform and a financial institution. In some embodiments, the plurality of rails enables transactions between the platform, and the blockchain rails that support the platform, and one or more user accounts at a financial institution, and the financial institution middleware supporting the digital account system of the financial institution. The platform may facilitate a transaction between a user account at a first financial institution and an omnibus account at a second financial institution. The omnibus account may be held in the name of the platform for the interest of one or more users (e.g., custodied by the platform in the interest of the users of the platform). The first financial institution and the second financial institution may be the same financial institution or different financial institutions. In some cases, the transfer of assets between the platform and the financial institution may be facilitated through the Automated Clearing House (ACH) network (e.g., an ACH transfer). A user may link an account held at a financial institution with their account on the platform. The user may provide financial institution account information needed to push or pull funds from the user's financial institution account to or from the platform omnibus account. In exchange for the currency or other asset exchanged with the user's financial institution account, the platform may burn or mint a stable coin on a blockchain ledger of the platform. As used herein, stable coin may refer to a cryptocurrency or digital token of a blockchain network that has a constant price or has its price tied to a fiat currency. As an example, a stable coin may be tied to the United States dollar and be valued at one token (coin) per dollar. Stable coins may be more easily transacted than fiat currencies, and may thus enable the efficiencies of the platform described herein. Additionally, the constant value of a stable coin, as compared to another type of cryptocurrency, provides greater reliability and resistance to volatility that may decrease an efficiency of transactions using the volatile token.

In some cases, the Account API can facilitate the user (e.g., the account holder) to enter information regarding the financial institution transfer (e.g., the ACH transfer). The Account API may store the request for the ACH transfer. The Account API may create an ACH transaction request (e.g., pull or push). The Account API may transmit that ACH transaction request to a financial institution integrated to the platform. Once the financial institution completes the transaction (e.g., ACH pull or push), the platform may broadcast the successful transaction to a blockchain supporting the platform. The blockchain may be configured to ledger one or more transactions of the platform (e.g. the successful ACH transaction).

### 6. Mint (Pull/Credit)

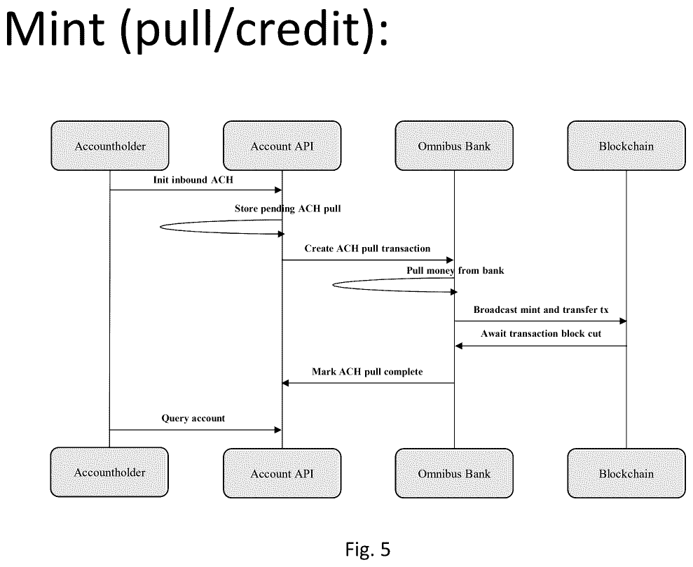

In some cases, the transaction between the platform and the financial institution may comprise an ACH pull or an ACH push. FIG. 5 shows an example of a process of the platform configured to mint or pull/credit an amount from a user financial institution account to the omnibus account. The steps shown in FIG. 5 may be performed in an alternative order, an order that include one or more additional steps, or any other order. The process may comprise an ACH pull transaction, where fiat currency is exchanged for one or more tokens of a distributed ledger of the platform. An ACH pull may refer to a transaction that debits, or removes currency from a financial institution account, and transfers the value of that currency to an omnibus account of the platform. The platform may pull the currency from a financial institution account of the user, transfer the currency to the omnibus account, and record the transaction on a blockchain ledger. The platform may also mint (e.g., create) one or more tokens based on a blockchain of the platform that correspond to the value of the currency transferred from the user's financial institution account to the omnibus account. The one or more tokens may comprise stablecoins unique to the platform's blockchain and digital wallets. Alternatively, or in addition, the one or more tokens may comprise one or more digital assets that are not unique to the platform's blockchain or digital wallet. After completion of the ACH pull transaction and minting of the blockchain stable coin or other token representing the value of the transferred currency, the Account API may be configured to allow the user to query the balance of tokens on the platform blockchain (e.g., held within a custodied wallet by the platform).

### 7. Burn (Push/Debit)

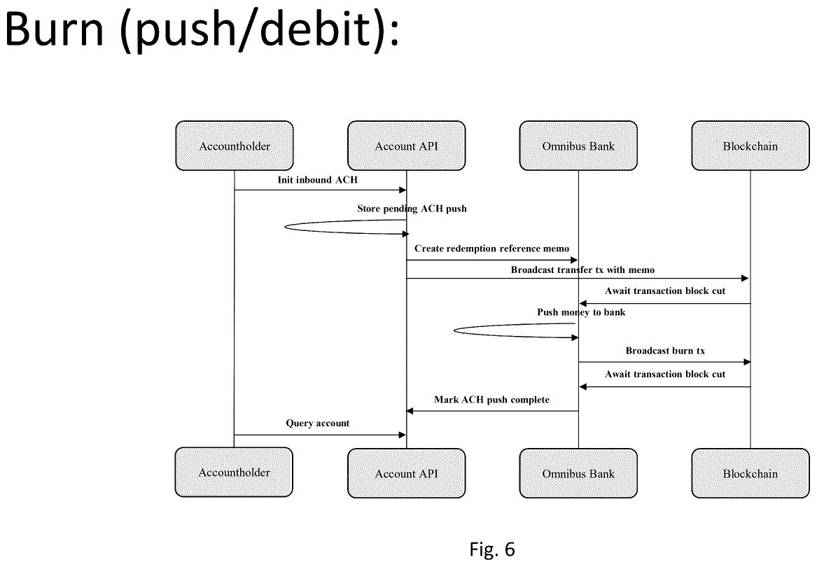

In some cases, the transaction between the platform and the financial institution may comprise an ACH pull or an ACH push. FIG. 6 shows an example of a process of the platform configured to burn or push/debit an amount from the omnibus account to a user account at a financial institution. The steps shown in FIG. 6 may be performed in an alternative order, an order that include one or more additional steps, or any other order. The process may comprise an ACH push transaction, where a token of the distributed ledger of the platform is exchanged for fiat currency. An ACH push may refer to a transaction that credits, or adds, currency to a financial institution account from an omnibus account of the platform. The platform may remove one or more tokens from a user account of the platform, where the one or more tokens are tokens of the distributed ledger of the platform corresponding to the value of the fiat currency transferred to the financial institution account from the omnibus account. The platform may record the transaction, including the successful burning (e.g., destruction) of the one or more tokens removed from the user account, on the blockchain. The one or more tokens may comprise stablecoins unique to a blockchain and/or digital wallet of the platform. Alternatively, or in addition, the one or more tokens may comprise one or more digital assets that are not unique to the platform's blockchain or digital wallet. After completion of the ACH push transaction and burning of the blockchain stable coin or other token representing the value of the transferred currency, the Account API may be configured to allow the user to query the balance of tokens on the platform blockchain (e.g., held within a custodied wallet by the platform).

### 8. In-Network Transactions

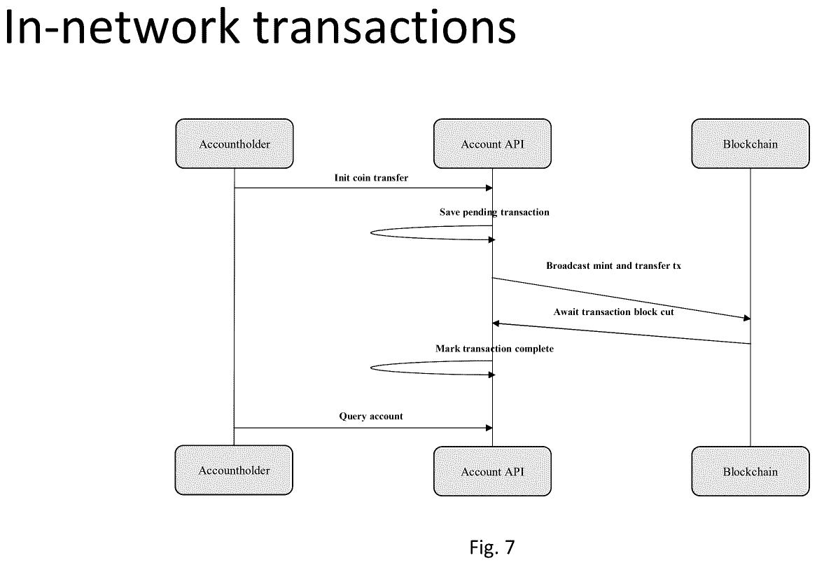

In some cases, the platform described herein may be configured to facilitate in-network transactions between two or more users. FIG. 7 shows an example of a process of the network configured to facilitate an in-network transaction. The steps shown in FIG. 7 may be performed in an alternative order, an order that include one or more additional steps, or any other order. The in-network transaction may comprise the transfer of a stablecoin from one user to another. The stablecoin may be unique to a rail of the platform based or build on blockchain. The Account API of the platform may be configured to facilitate a user initiating a coin transfer (e.g., a transfer of a value or amount of stablecoin via a blockchain rail). The Account API may save the pending transaction. The Account API may broadcast one or more details of the transaction to a blockchain ledger. The one or more details of the transaction may comprise the amount of currency being transferred, identification information for the parties involved in the transaction, the time and/or date of the transaction, or other information used in the validation of the transaction. The blockchain may cut a new block (e.g., record the transaction, or one or more details of the transaction to the blockchain). Once the new block has been cut, and the transaction is recorded to the blockchain ledger, the Account API may mark the transaction as complete. The Account API may be configured to allow a user to query the Account (e.g., request information regarding the account balance, recent transaction history, or other account information).

### 9. Debit Card Transactions

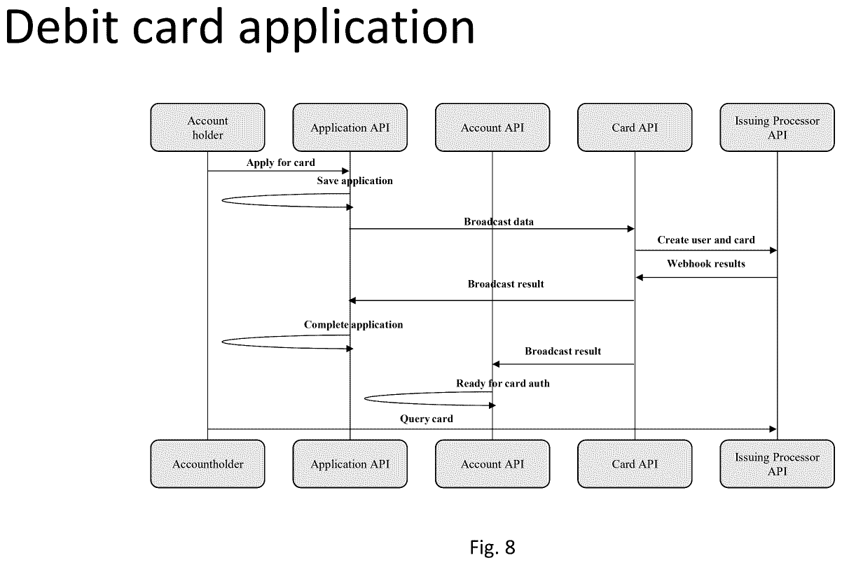

In an aspect, the platform of the present disclosure may be configured to facilitate debit card transactions. FIG. 8 shows a process of the platform that can be configured to facilitate a debit card transaction. The steps shown in FIG. 8 may be performed in an alternative order, an order that include one or more additional steps, or any other order. The platform may comprise an Application API, an Account API, a Card API, and/or a debit card provider API. The Application API may be configured to request information from a new user regarding an application for a debit card linked to the new user's account on the platform. The Account API may be configured to store the user's account information which may comprise account information related to a debit card. The Card API may be configured to communicate or otherwise integrate with an external debit card provider (such as a debit card provider API).

In some cases, the Application API may facilitate an accountholder, or prospective account holder, to submit an application to create a debit card account on the platform, or to add a debit card linked to an existing account of the user on the platform. The Application API may be configured to save the application (e.g., the application data). The Application API may be configured to broadcast the application data to the Card API. The Card API may be configured to process the application data. The Card API may create a user account and debit card associated with the user account or may create a debit card associated with an existing account of the user. The Card API may be configured to transmit the application data, or the processed application data, to a debit card provider. The debit card provider may receive the application data, or the processed application data, from the Card API through an external debit card provider API. The external debit card provider API may generate one or more Webhook results relating to the creation of a debit card associated with a user account of the platform. The Card API may receive the Webhook results and, in turn, broadcast the result of the debit card application and creation to an Account API. The Account API may be configured to update one or more permissions, details, or accounts associated with an account of a user to reflect the result of the Card API application and debit card generation actions. If the application and generation of a debit card associated with an account of a user is successful and complete, the Card API may be configured to facilitate a user querying one or more details about the debit card account. The one or more details may comprise a present balance of the account and/or transaction history of the account.

### Computer Systems

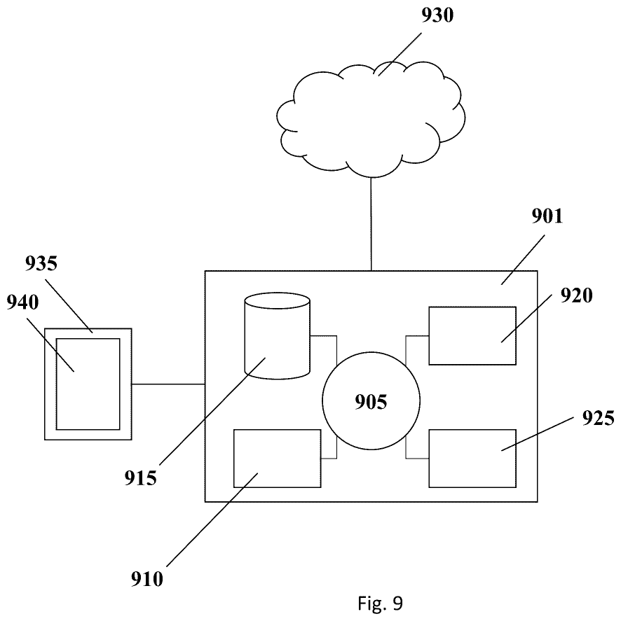

In another aspect, the present disclosure provides computer systems that are programmed or otherwise configured to implement methods of the disclosure. Referring to FIG. 9, the computer system 901 may be programmed or otherwise configured to implement a method transferring funds using an integrated financial services platform. The computer system 901 may be configured to, for example, record a transaction of the integrated financial services platform on a distributed ledger. The computer system 901 can be an electronic device of a user or a computer system that is remotely located with respect to the electronic device. The computer system 901 can be a cloud server.

The computer system 901 may include a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are located external to the computer system 901 (e.g., on a remote server that is in communication with the computer system 901 through an intranet or the Internet).

The computer system 901 can communicate with one or more remote computer systems through the network 930. For instance, the computer system 901 can communicate with a remote computer system of a user (e.g., a merchant or end user). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface (UI) 940 for providing, for example, a portal for a user to interact with the financial services platform. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. For example, the algorithm may be configured to generate a visual code that is indicative or representative of a transaction amount of settlement between a first party and a second party.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-42. (canceled).

43. An integrated financial services platform, comprising:
a plurality of rails that are based or built on a blockchain, wherein the plurality of rails are configured to enable a plurality of financial transactions comprising direct deposits, money transfers, debits, financed purchases, or point of sale loans between a plurality of parties; and
an application for implementing the plurality of rails, wherein the application is executable on a plurality of devices and comprises a graphical user interface for facilitating the financial transactions between the plurality of parties, wherein at least one of the financial transactions is completed by using a visual code that is indicative or representative of a transaction amount or settlement between a first party and a second party.

44. The platform of claim 43, wherein the application is a mobile application (app) or web-based.

45. The platform of claim 43, wherein the visual code comprises a two-dimensional code.

46. The platform of claim 45, wherein the two-dimensional code comprises a quick response (QR) code.

47. The platform of claim 43, wherein the visual code is associated with an invoice from the first party to the second party.

48. The platform of claim 43, wherein the application is configured to generate the visual code for the first party, wherein the visual code is subsequently displayed or transmitted by the first party to the second party.

49. The platform of claim 43, wherein the application is configured to enable the first party to transmit the visual code via text message or email to the second party.

50. The platform of claim 48, wherein the at least one financial transaction is completed or settled substantially in real-time upon the second party scanning or processing the visual code using a device.

51. The platform of claim 48, wherein the visual code comprises metadata about the first party, nature of the at least one financial transaction, and a timestamp.

52. The platform of claim 51, wherein the visual code further comprises metadata about the second party.

53. The platform of claim 48, wherein the visual code is specific only to the second party, such that the at least one financial transaction is unable to be completed if the visual code is scanned or processed by another party that is not the second party.

54. The platform of claim 43, wherein the platform is configured to integrate transactional data from the plurality of financial transactions into a contextual rewards program offered by one or more of the plurality of parties.

55. The platform of claim 54, wherein the platform is configured to use the blockchain as a system or a record for accumulation, redemption or transfer of points or rewards for the contextual rewards program.

56. The platform of claim 55, wherein the platform is configured to generate one or more geolocation alerts associated with the contextual rewards program, based on a geographical proximity between a first party that is offering the contextual rewards program and a second party that is a customer or potential customer of the first party.

57. The platform of claim 43, further comprising: an analytics module that is configured to apply one or more machine learning algorithms to transactional data from the plurality of financial transactions for an underwriting process.

58. The platform of claim 57, wherein the application is configured to generate one or more visual codes that are indicative of credit offers for extending to one or more parties based on results of the underwriting process.

59. The platform of claim 43, wherein the platform is configured to host a plurality of accounts with funds or balances, and wherein the blockchain is configured to maintain all of the plurality of accounts, the funds or balances, and the plurality of financial transactions, by extending across the plurality of rails and supporting a fiat bridge interface to at least some of the rails.

60. The platform of claim 43, wherein the platform is configured to incorporate and custody cryptocurrency wallets.

61. The platform of claim 43, wherein the plurality of parties are accountholders on the platform, and wherein each account associated with the corresponding accountholders represents a wallet on the blockchain.

62. The platform of claim 43, wherein the platform is configured to allow the plurality of parties to earn transaction income from the plurality of financial transactions occurring across the plurality of rails.
